(19) United States
(12) Patent Application Publication
(10) Pub. No.: US 2023/0090981 A1
(43) Pub. Date: Mar. 23, 2023

(54) MICRO-ENCAPSULATED PHASE-CHANGE MATERIAL, PREPARATION METHOD THEREOF, AND PILLOW COMPRISING THE SAME

(71) Applicant: Wuxi JHT Homewares Co., Ltd., Wuxi (CN)

(72) Inventor: Yong WAN, Wuxi (CN)

(21) Appl. No.: 17/725,518

(22) Filed: Apr. 20, 2022

(30) Foreign Application Priority Data
Sep. 18, 2021 (CN) 202122277813.3
Jan. 10, 2022 (CN) 202210021777.0

(51) Int. Cl. C09K 5/06; C08J 9/28; A47G 9/10; C08L 33/12

(52) U.S. Cl. CPC C09K 5/063; C08J 9/28; A47G 9/1036; C08L 33/12; C08J 2201/0504; C08J 2313/02; C08J 2375/04; A47G 2009/1018

(57) ABSTRACT

A micro-encapsulated phase-change material (MEPCM), includes, by weight: 120-150 parts of a phase-change material; 25-30 parts of methyl methacrylate; 1-4 parts of methacrylic acid; 45-54 parts of butyl acrylate; 0.2-0.7 parts of an initiator; 10-12 parts of an emulsifier; and 600-700 parts of deionized water.

### CROSS-REFERENCE TO RELATED APPLICATIONS

Pursuant to 35 U.S.C. § 119 and the Paris Convention Treaty, this application claims foreign priority to Chinese Patent Application No. 202122277813.3 filed Sep. 18, 2021, and to Chinese Patent Application No. 202210021777.0 filed Jan. 10, 2022. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure relates to a micro-encapsulated phase-change material, a preparation method thereof, and a pillow comprising the same.

Conventional latex pillow and polyurethane sponge pillow including phase change material microcapsules are difficult to manufacture. Moreover, the fabrics of the pillows are compact, it is inconvenient for phase change material to contact with the head of the users, affecting the user experience.

### SUMMARY

The disclosure provides a micro-encapsulated phase-change material (MEPCM), comprising, by weight:
120-150 parts of a phase-change material;
25-30 parts of methyl methacrylate;
1-4 parts of methacrylic acid;
45-54 parts of butyl acrylate;
0.2-0.7 parts of an initiator;
10-12 parts of an emulsifier; and
600-700 parts of deionized water.

In a class of this embodiment, the phase change material is selected from the group consisting of n-alkanes, n-alkanols and fatty acid esters, and n-alkanes are selected from the group consisting of n-hexadecane, n-octadecane, n-eicosane and n-Docosane; n-alkanols are selected from the group consisting of n-dodecanol, n-tetradecanol and n-octadecanol, and fatty acid esters are selected from the group consisting of butyl stearate, methyl palmitate, ethyl palmitate, and paraffin.

In a class of this embodiment, the initiator is ammonium persulfate or potassium persulfate.

In a class of this embodiment, the initiator is selected from the group consisting of polyvinyl alcohol, gelatin, and sodium rosin.

The disclosure also provides a method for preparing the MEPCM, the method comprising:

mixing the phase-change material, methyl methacrylate, methacrylic acid, butyl acrylate, and the initiator, to yield a mixture; melting the mixture at 60-100° C., to yield an oil phase;

mixing the emulsifier and deionized water to yield an aqueous phase;

adding the oil phase to the aqueous phase, stirring, emulsifying, to yield an emulsion; under dispersion conditions, heating the emulsion to 70-90° C., adjusting pH of the emulsion to 5-8, stirring at high speed for 3-4 hours for polymerization, reducing a stirring speed and temperature below a melting point of a core material, to yield a phase change material microcapsule suspension; and

filtering, vacuuming, and removing water, to yield a polyacrylate encapsulated phase change material microencapsulated emulsion.

In a class of this embodiment, the phase-change material is a core material of the MEPCM, and methyl methacrylate, methacrylic acid, and butyl acrylate are mixed in the initiator to yield polyacrylate as a shell layer of the MEPCM; and a mass ratio of the core material to the shell layer is between 1:3 and 1:6.

In a class of this embodiment, the MEPCM has a particle size of 30-100 μm.

Further, the disclosure provides a pillow, comprising a pillowcase and a pillow core disposed in the pillowcase; the pillow core comprises polyurethane sponge or latex material, and the surface of the pillow core is coated with the micro-encapsulated phase-change material in the form of microencapsulated emulsion.

In a class of this embodiment, the pillowcase is a splicing structure, the pillow case comprises knitted and woven fabrics of ultra-high molecular polyethylene fiber, all cotton, all polyester and polyester-cotton blend, and the pillow case comprises fabrics at upper and lower ends of the pillow core and side mesh connecting the fabrics together.

The following advantages are associated with the micro-encapsulated phase-change material of the disclosure: the micro-encapsulated phase-change material can be synthesized conveniently, with easy operation steps, and the prepared phase change material microcapsule is highly stable, can better integrate with the pillow core. When the phase change material microcapsule is applied to a pillow, the user directly contacts with the phase change material, thus improving the sleep quality.

### DETAILED DESCRIPTION

To further illustrate, embodiments detailing a micro-encapsulated phase-change material are described below. It should be noted that the following embodiments are intended to describe and not to limit the disclosure.

### EXAMPLE 1

The disclosure provides a micro-encapsulated phase-change material (MEPCM), comprising, by weight:
120-150 parts of a phase-change material;
25-30 parts of methyl methacrylate;
1-4 parts of methacrylic acid;
45-54 parts of butyl acrylate;
0.2-0.7 parts of an initiator;
10-12 parts of an emulsifier; and
600-700 parts of deionized water.

In certain embodiments, the phase change material is selected from the group consisting of n-alkanes, n-alkanols, fatty acid esters, or a mixture thereof, and n-alkanes are selected from the group consisting of n-hexadecane, n-octadecane, n-eicosane, n-Docosane, or a mixture thereof; n-alkanols are selected from the group consisting of n-dodecanol, n-tetradecanol, n-octadecanol, or a mixture thereof, and fatty acid esters are selected from the group consisting of butyl stearate, methyl palmitate, ethyl palmitate, or a mixture thereof, or paraffin.

The initiator is ammonium persulfate or potassium persulfate.

The initiator is selected from the group consisting of polyvinyl alcohol, gelatin, and sodium rosin.

### EXAMPLE 2

The disclosure also provides a method for preparing the MEPCM, the method comprising:

1. mixing the phase-change material, methyl methacrylate, methacrylic acid, butyl acrylate, and the initiator, to yield a mixture; melting the mixture at 60-100° C., to yield an oil phase;

specifically, the phase-change material is a core material of the MEPCM, and methyl methacrylate, methacrylic acid, and butyl acrylate are mixed in the initiator to yield polyacrylate as a shell layer of the MEPCM; and a mass ratio of the core material to the shell layer is between 1:3 and 1:6; thus, the MEPCM is a core-shell structure, with good stability, and is easy to compound with other articles;

2. mixing the emulsifier and deionized water to yield an aqueous phase; deionized water can improve the synthesis rate and then improve the yield of the aqueous phase;

3. adding the oil phase to the aqueous phase, stirring, emulsifying, to yield an emulsion; under dispersion conditions, heating the emulsion to 70-90° C., adjusting pH of the emulsion to 5-8, stirring at high speed for 3-4 hours for polymerization, reducing a stirring speed to 2000-5000 rpm and temperature below a melting point of a core material, to yield a phase change material microcapsule suspension; the MEPCM has a particle size of 30-100 μm; and

4. filtering, vacuuming, and removing water from the phase change material microcapsule suspension, to yield a polyacrylate encapsulated phase change material microencapsulated emulsion.

### EXAMPLE 3

The disclosure further provides a pillow, comprising a pillowcase and a pillow core disposed in the pillowcase; the pillow core comprises polyurethane sponge or latex material, and the surface of the pillow core is coated with the micro-encapsulated phase-change material in the form of microencapsulated emulsion. Thus, a phase change material microcapsule coating is formed on the surface of the pillow core, which enables the characteristics of the phase change material are exhibited on the pillow core, facilitates the contact between phase change material and the body, and promote sleep effect. The pillow core is made of polyurethane sponge or latex material, which is convenient for the combination of the pillow core and the phase change material.

The pillowcase is a splicing structure, the pillow case comprises knitted and woven fabrics of ultra-high molecular polyethylene fiber, all cotton, all polyester and polyester-cotton blend, and the pillow case comprises fabrics at upper and lower ends of the pillow core and side mesh connecting the fabrics together. The pillow core can be well covered. And meanwhile, the user can contact with the phase change material microcapsule coating on the pillow core through the above polymer materials comprising ultra-high molecular polyethylene fiber, all cotton, all polyester and polyester-cotton blend, thus improving the sleep effect.

It will be obvious to those skilled in the art that changes and modifications may be made, and therefore, the aim in the appended claims is to cover all such changes and modifications.

The invention claimed is:

1. A micro-encapsulated phase-change material (MEPCM), comprising, by weight:
120-150 parts of a phase-change material;
25-30 parts of methyl methacrylate;
1-4 parts of methacrylic acid;
45-54 parts of butyl acrylate;
0.2-0.7 parts of an initiator;
10-12 parts of an emulsifier; and
600-700 parts of deionized water.

2. The MEPCM of claim 1, wherein the phase change material is selected from the group consisting of n-alkanes, n-alkanols and fatty acid esters, and n-alkanes are selected from the group consisting of n-hexadecane, n-octadecane, n-eicosane and n-Docosane; n-alkanols are selected from the group consisting of n-dodecanol, n-tetradecanol and n-octadecanol, and fatty acid esters are selected from the group consisting of butyl stearate, methyl palmitate, ethyl palmitate, and paraffin.

3. The MEPCM of claim 1, wherein the initiator is ammonium persulfate or potassium persulfate.

4. The MEPCM of claim 1, wherein the initiator is selected from the group consisting of polyvinyl alcohol, gelatin, and sodium rosin.

5. A method for preparing the MEPCM of claim 1, the method comprising:
mixing the phase-change material, methyl methacrylate, methacrylic acid, butyl acrylate, and the initiator, to yield a mixture; melting the mixture at 60-100° C., to yield an oil phase;
mixing the emulsifier and deionized water to yield an aqueous phase;
adding the oil phase to the aqueous phase, stirring, emulsifying, to yield an emulsion; under dispersion conditions, heating the emulsion to 70-90° C., adjusting pH of the emulsion to 5-8, stirring at high speed for 3-4 hours for polymerization, reducing a stirring speed and temperature below a melting point of a core material, to yield a phase change material microcapsule suspension; and
filtering, vacuuming, and removing water from the phase change material microcapsule suspension, to yield a polyacrylate encapsulated phase change material microencapsulated emulsion.

6. The method of claim 5, wherein the phase-change material is a core material of the MEPCM, and methyl methacrylate, methacrylic acid, and butyl acrylate are mixed in the initiator to yield polyacrylate as a shell layer of the MEPCM; and a mass ratio of the core material to the shell layer is between 1:3 and 1:6.

7. The method of claim 5, wherein the MEPCM has a particle size of 30-100 μm.

8. A pillow, comprising a pillowcase and a pillow core disposed in the pillowcase; wherein the pillow core comprises polyurethane sponge or latex material, and a surface of the pillow core is coated with a micro-encapsulated phase-change material of claim 1 in the form of microencapsulated emulsion.

9. The pillow of claim 8, wherein the pillowcase is a splicing structure, the pillow case comprises knitted and woven fabrics of ultra-high molecular polyethylene fiber, all cotton, all polyester and polyester-cotton blend, and the pillow case comprises fabrics at upper and lower ends of the pillow core and side mesh connecting the fabrics together.
